(19) United States
(12) Patent Application Publication
(10) Pub. No.: US 2013/0221670 A1
(43) Pub. Date: Aug. 29, 2013

(54) WIND TURBINE GENERATOR SYSTEM, CONTROL APPARATUS THEREFOR, AND CONTROL METHOD THEREFOR

(71) Applicant: Akira YASUGI, Tokyo (JP)

(72) Inventor: Akira YASUGI, Tokyo (JP)

(73) Assignee: MITSUBISHI HEAVY INDUSTRIES, LTD., Tokyo (JP)

(21) Appl. No.: 13/531,208

(22) Filed: Jun. 22, 2012

Related U.S. Application Data
(63) Continuation of application No. PCT/JP2012/054565, filed on Feb. 24, 2012.

(51) Int. Cl. H02P 9/04

(52) U.S. Cl. 290/44

(57) ABSTRACT

An object is to swiftly respond to a demand made in terms of electric energy from the grid side when an output-power reduction operation is performed. A wind-turbine-generator-system control apparatus includes: an output-power predicting section that estimates a future output-power prediction curve from wind-condition prediction information indicating predicted future wind conditions; and a first setting section that divides the output-power prediction curve into a predetermined number of time segments and sets, for each of the time segments, a first target electric-power value for making reserve electric energy in the corresponding time segment match demand reserve electric energy demanded by the grid side. The output power of each of the wind turbines is controlled based on the first target electric-power value.

### CROSS REFERENCE TO RELATED APPLICATIONS

This is a continuation of International Application PCT/JP2012/054565, with an international filing date of Feb. 24, 2012, which is hereby incorporated by reference herein in its entirety.

### TECHNICAL FIELD

The present invention relates to a wind turbine generator system, a control apparatus therefor, and a control method therefor.

### BACKGROUND ART

In recent years, in a wind farm equipped with a plurality of wind turbines, an operation is performed to intentionally reduce the output power of each wind turbine to ensure reserve output power.

For example, United States Patent Application, Publication No. 2010/0286835 discloses a method in which wind-speed-versus-output-power characteristics corresponding to an output-power reduction operation are set in advance, a target output power corresponding to the wind speed at each moment is obtained by using this wind-speed-versus-output-power curve, and each wind turbine is controlled so as to attain the target output power.

### CITATION LIST

### Patent Literature

{PTL 1} United States Patent Application, Publication No. 2010/0286835

### SUMMARY OF INVENTION

### Technical Problem

In the method disclosed in United States Patent Application, Publication No. 2010/0286835, electric power reduction is performed with reference to the electric power value at each time. However, in future operation, it is expected that a demand for output-power reduction will be made in terms of electric energy (kW·h) for a predetermined period of time, instead of electric power (kW).

The present invention provides a wind turbine generator system, a control apparatus for the wind turbine generator system, and a control method therefor in which, when the output-power reduction operation is performed, if a demand is made in terms of electric energy from the grid side, it is possible to swiftly respond thereto.

### Solution to Problem

According to a first aspect, the present invention provides a wind-turbine-generator-system control apparatus that is applied to a wind turbine generator system in which output powers of a plurality of wind turbines are supplied to a utility grid via a common interconnection point, the control apparatus including: an output-power predicting section that estimates a future output-power prediction curve from wind-condition prediction information indicating predicted future wind conditions; and a first setting section that divides the output-power prediction curve estimated by the output-power predicting section into a predetermined number of time segments and sets, for each of the time segments, a first target electric-power value for making reserve electric energy in the corresponding time segment match demand reserve electric energy demanded by the grid side, in which the output power of each of the wind turbines is controlled based on the first target electric-power value.

According to a second aspect, the present invention provides a wind-turbine-generator-system control method that is applied to a wind turbine generator system in which output powers of a plurality of wind turbines are supplied to a utility grid via a common interconnection point, the control method including: an output-power estimating step of estimating a future output-power prediction curve from wind-condition prediction information indicating predicted future wind conditions; and a first setting step of dividing the estimated output-power prediction curve into a predetermined number of time segments and setting, for each of the time segments, a first target electric-power value for making reserve electric energy in the corresponding time segment match demand reserve electric energy demanded by the grid side, in which the output power of each of the wind turbines is controlled based on the first target electric-power value.

According to a third aspect, the present invention provides a wind turbine generator system including: a plurality of wind turbines; and the above-described wind-turbine-generator-system control apparatus.

### Advantageous Effects of Invention

According to the present invention, an advantage is afforded in that, when the output-power reduction operation is performed, even if a demand is made in terms of electric energy from the grid side, it is possible to swiftly respond thereto.

### BRIEF DESCRIPTION OF DRAWINGS

FIG. 1 is a diagram showing the entire configuration of a wind turbine generator system according to one embodiment of the present invention.

FIG. 2 is an outline view of a wind turbine shown in FIG. 1.

FIG. 3 is a schematic view showing, in outline, the electrical configuration of the wind turbine shown in FIG. 1.

FIG. 4 is a diagram showing an example hardware configuration of a central control system shown in FIG. 1.

FIG. 5 is a functional block diagram mainly showing functions related to output-power reduction control among the functions of the central control system shown in FIG. 1.

FIG. 6 is a diagram showing example conversion information.

FIG. 7 is a diagram showing an example output-power prediction curve.

FIG. 8 is a diagram for explaining a first target electric-power value.

FIG. 9 is a diagram showing an example active power command set based on the first target electric-power value shown in FIG. 8.

FIG. 10 is diagram for explaining a second target electric-power value.

### DESCRIPTION OF EMBODIMENTS

A wind turbine generator system, a control apparatus therefor, and a control method therefor according to one embodiment of the present invention will be described below with reference to the drawings.

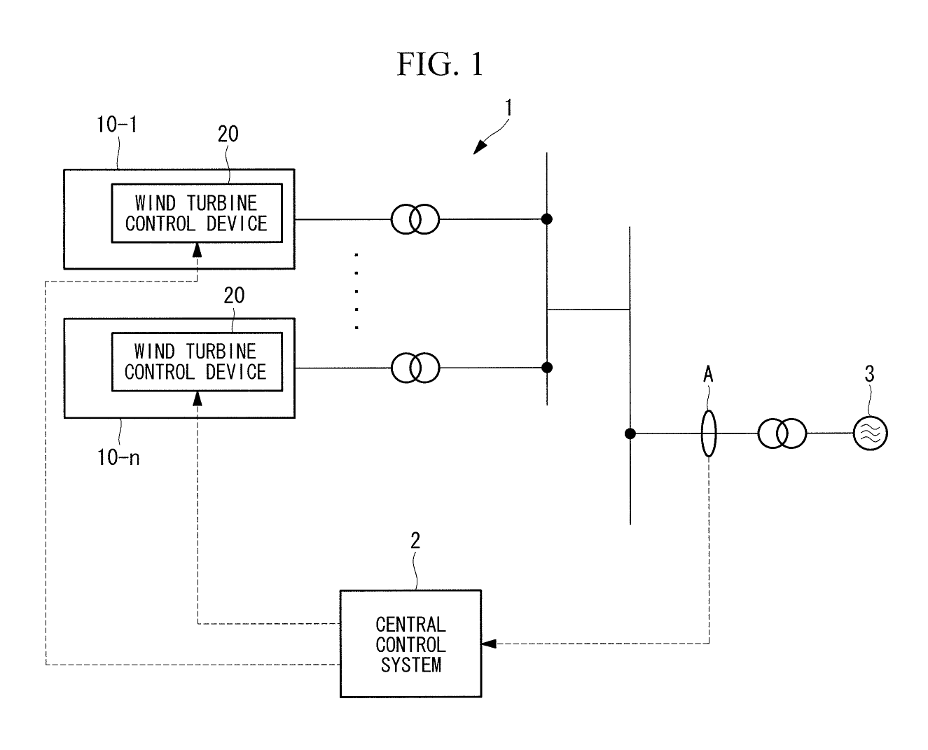

FIG. 1 is a diagram showing the entire configuration of the wind turbine generator system according to this embodiment. As shown in FIG. 1, a wind turbine generator system 1 includes a plurality of wind turbines 10-1, . . . , 10-n (hereinafter, reference numeral “10” is simply assigned to indicate the wind turbines as a whole, and reference symbols “10-1”, “10-n”, and the like are assigned to indicate individual wind turbines) and a central control system 2 that gives output power commands to the wind turbines 10.

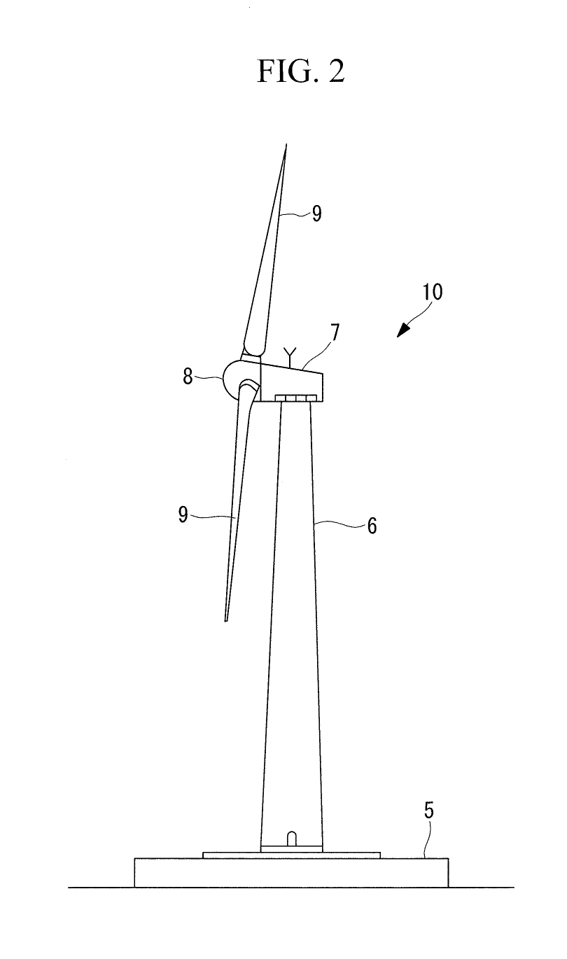

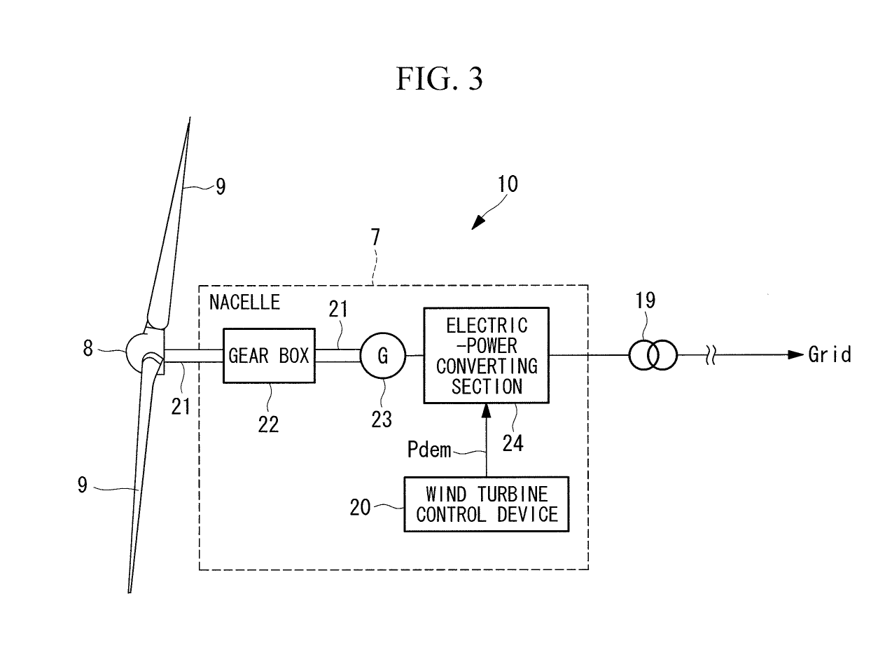

In this embodiment, the wind turbines 10 are variable-speed wind turbines whose individual rotational speeds can be controlled according to the wind speed. FIG. 2 is an outline view of the wind turbine 10. FIG. 3 is a schematic view showing the electrical configuration of the wind turbine 10.

As shown in FIG. 2, the wind turbine 10 has a tower 6 provided upright on a foundation 5, a nacelle 7 provided on the top of the tower 6, and a rotor head 8 provided on the nacelle 7 so as to be capable of rotating about a substantially horizontal axis.

A plurality of blades 9 are attached to the rotor head 8 in a radiating pattern from the rotational axis of the rotor head 8. The blades 9 are coupled to the rotor head 8 so as to be capable of turning according to the operating conditions, so that the pitch angles of the blades 9 can be changed.

As shown in FIG. 3, a gear box 22 and a generator 23 are mechanically coupled to a rotational shaft 21 of the rotor head 8. The generator 23 may be a synchronous generator or an induction generator. A configuration in which the gear box 22 is not provided can be used.

The force of wind striking the blades 9 from the direction of the rotational axis of the rotor head 8 causes the rotor head 8 to rotate about the rotational axis, and the rotative force is increased in speed by the gear box 22 and is transferred to the generator 23 to be converted to electrical power. Electrical power generated by the generator 23 is converted by an electric-power converting section 24 to electrical power for the utility grid 3 and is supplied to the utility grid 3 via a transformer 19.

The electric-power converting section 24 and the pitch angles of the blades 9 are controlled by a wind turbine control device 20 provided in each wind turbine.

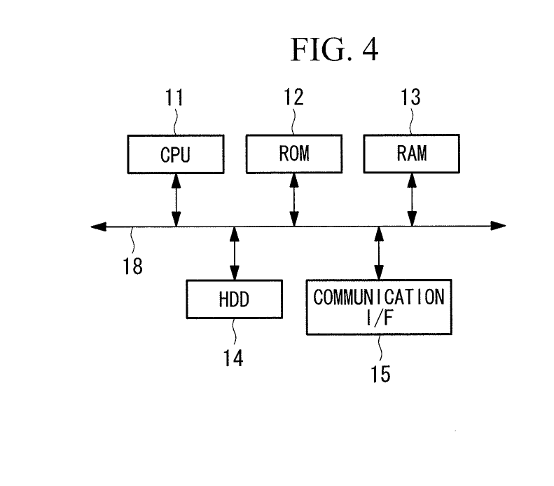

The central control system 2 and the wind turbine control device 20 each have a computer. For example, as shown in FIG. 4, each of the central control system 2 and the wind turbine control device 20 includes, as main components, a CPU 11, a ROM (read only memory) 12 for storing a program to be executed by the CPU 11, a RAM (random access memory) 13 that functions as a working area when the program is executed, a hard disk drive (HDD) 14 serving as a large-capacity storage unit, and a communication interface 15 for connecting to a network. These units are connected via a bus 18. Furthermore, the central control system 2 may include an access unit to which an external storage device is attached, an input unit formed of a keyboard and a mouse, and a display unit formed of a liquid crystal display device that displays data.

The storage medium for storing the program executed by the CPU 11 is not limited to the ROM 12. For example, another auxiliary storage device, such as a magnetic disk, a magneto optical disk, and a semiconductor memory, may be used.

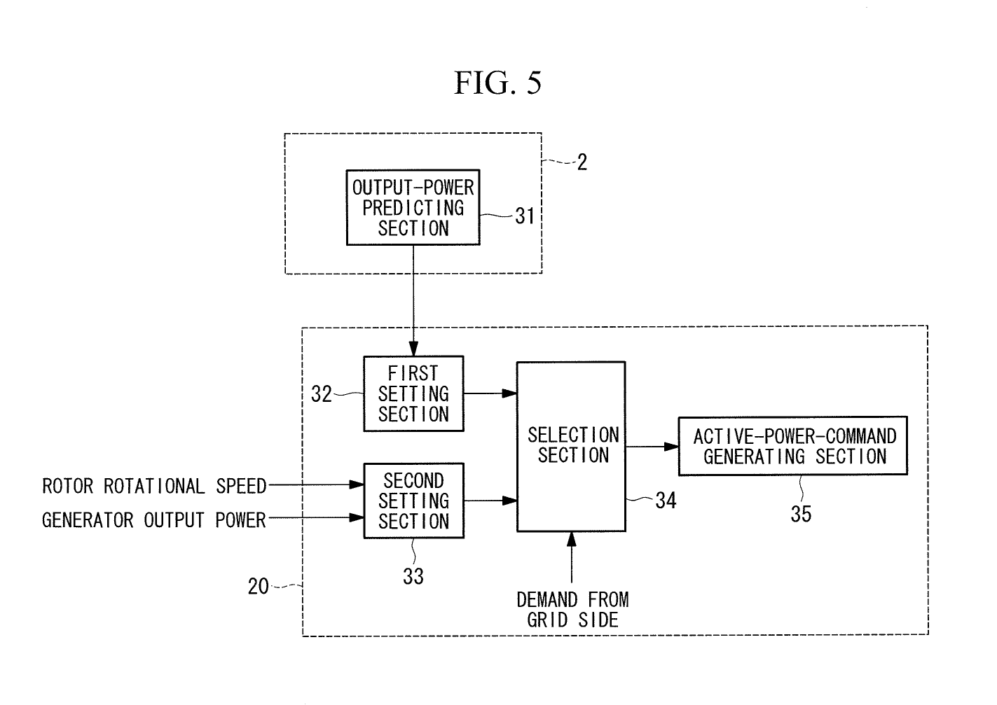

FIG. 5 is a functional block diagram of the central control system 2 and the wind turbine control device 20. Processing realized by respective sections included in the central control system 2 and the wind turbine control device 20 shown in FIG. 5 is realized when the program stored in the ROM 12 is read into the RAM 13 and executed by the CPU 11.

As shown in FIG. 5, the central control system 2 includes an output-power predicting section 31. The output-power predicting section 31 acquires, for example, wind-condition prediction information indicating predicted future wind conditions from an external database via a network and predicts a future output-power prediction curve from the wind-condition prediction information.

The wind-condition prediction information is, for example, mesoscale-model wind-condition prediction information provided by a Meteorological Agency. Furthermore, based on meteorological data provided by the Meteorological Agency and terrain data about the area where each wind turbine is installed, more-highly-accurate wind-condition prediction may be performed in consideration of the terrain, and the wind-condition prediction information thus obtained may be adopted.

Furthermore, instead of acquiring the wind-condition prediction information from outside, the output-power predicting section 31 may have a wind-condition predicting function and may perform output-power prediction based on wind-condition prediction information acquired by itself. Examples of the wind-condition predicting function include a lidar system. In this way, the method of acquiring the wind-condition prediction information is not particularly limited.

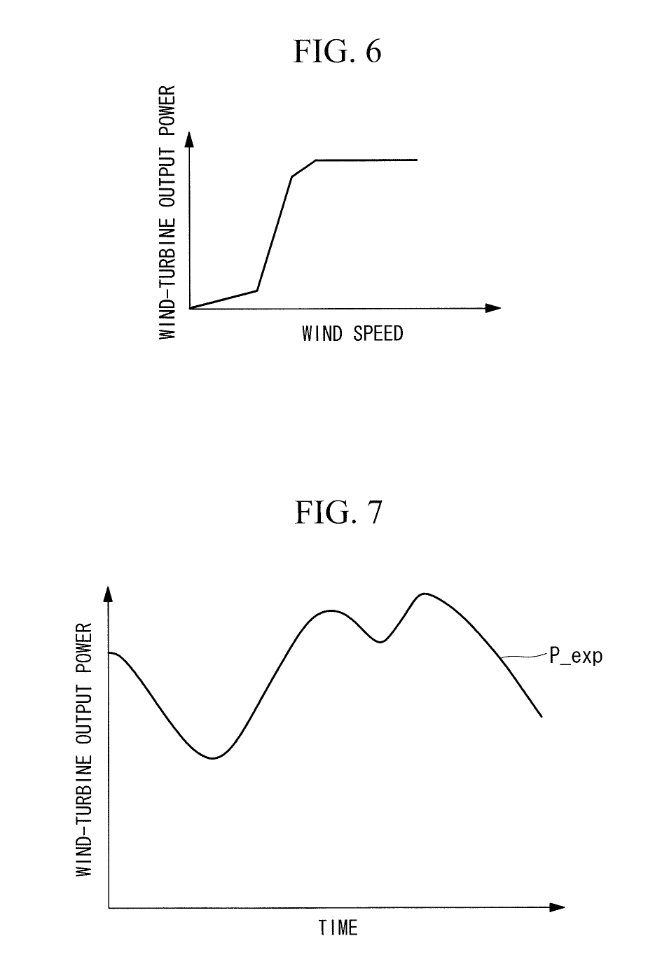

By using the above-described wind-condition prediction information, for example, the output-power predicting section 31 repeatedly predicts the output power of each wind turbine at predetermined time intervals for a given time (for example, for 12 hours) from the current time. Specifically, the output-power predicting section 31 has, for example, conversion information in which wind speed and wind-turbine output power are associated, as shown in FIG. 6, and generates a future output-power prediction curve for each wind turbine by using the conversion information. FIG. 7 shows an example output-power prediction curve P_exp. In FIG. 7, the horizontal axis indicates time, and the vertical axis indicates wind-turbine output power.

The output-power prediction curve may be individually generated for each wind turbine based on the wind speed at the place where that wind turbine is installed or may be generated for a wind-turbine group having a plurality of wind turbines by regarding the wind speed in the area where the wind turbines are installed as uniform. The thus-generated output-power prediction curve is sent to the wind turbine control device 20 of each wind turbine.

The wind turbine control device 20 includes a first setting section 32, a second setting section 33, a selection section 34, and an active-power-command generating section 35.

As shown in FIG. 8, the first setting section 32 divides the output-power prediction curve P_exp estimated by the output-power predicting section 31 into predetermined time segments D1, D2, and D3 and sets, for each of the time segments D1, D2, and D3, a first target electric-power value Pd1 for making reserve electric energy W_pot in the corresponding time segment D1, D2, or D3 match demand reserve electric energy W_ref demanded by the grid side. Each of the time segments D1, D2, and D3 is set to 15 minutes, for example.

Specifically, the first setting section 32 sets a first target electric-power value Pd1 that satisfies Formula (1).

W_pot =∫(P_exp−Pd1)dt=W_req (1)

In Formula (1), the domain of integration is the period of time of each of the time segments D1, D2, and D3. In Formula (1), W_pot corresponds to a hatched portion in each time segment shown in FIG. 8. The first target electric-power value Pd1 set by the first setting section 32 is output to the selection section 34, in association with the corresponding time segment.

The second setting section 33 performs a predetermined calculation by using the rotor rotational speed and the generator output power of the corresponding wind turbine to estimate the current wind-turbine output power P_pot and sets a second target electric-power value Pd2 obtained by subtracting a predetermined amount ΔP from the estimated wind-turbine output power. Specifically, the second target electric-power value Pd2 is expressed by Formula (2).

Pd2=P_pot−ΔP (2)

For the above-described predetermined amount ΔP, the value notified from the grid side as a reserve electric-power value is adopted, for example.

The selection section 34 selects the first target electric-power value Pd1 or the second target electric-power value Pd2 according to a demand from the grid side and outputs the selected target electric-power value to the active-power-command generating section 35. Specifically, if a demand in terms of electric energy (kW·h) is received from the grid side during the output-power reduction operation, the selection section 34 selects and outputs the first target electric-power value Pd1. Furthermore, if a demand in terms of electric power (kW) is received from the grid side during the output-power reduction operation, the selection section 34 selects and outputs the second target electric-power value Pd2. The demand from the grid may be directly input from the grid side to each wind turbine control device 20 or may be input via the central control system 2.

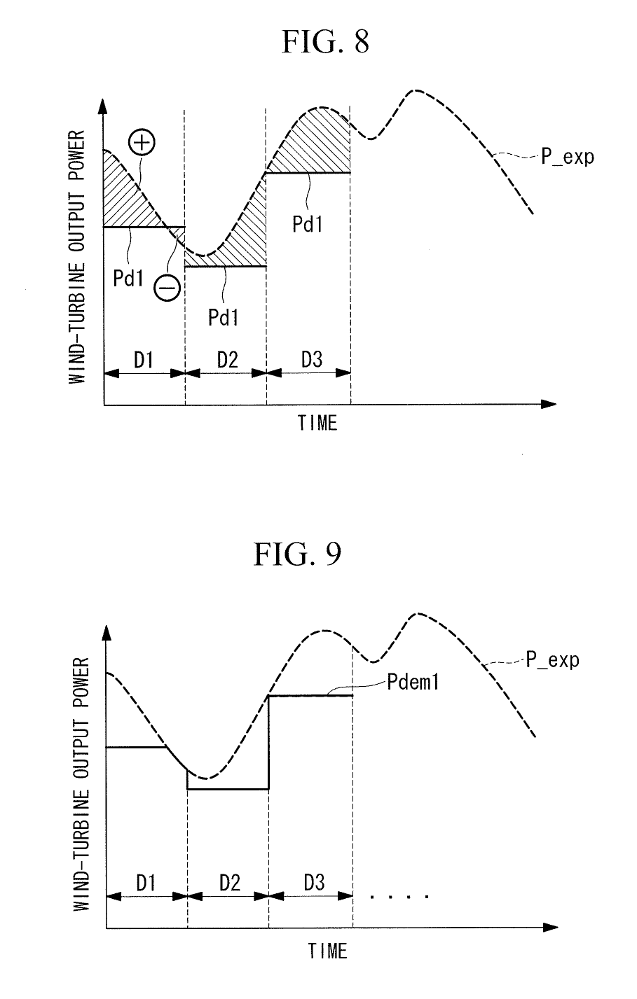

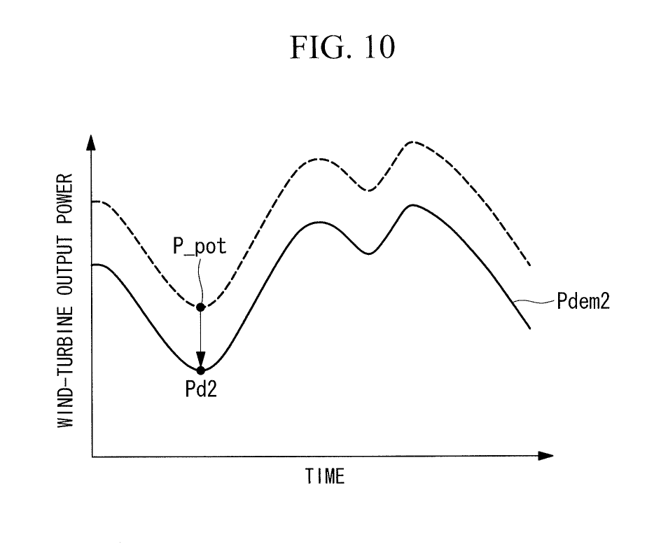

When the selection section 34 selects the first target electric-power value Pd1, the active-power-command generating section 35 generates an active power command Pdem1 based on the first target electric-power value Pd1. Furthermore, when the selection section 34 selects the second target electric-power value Pd2, the active-power-command generating section 35 generates an active power command Pdem2 based on the second target electric-power value Pd2. FIG. 9 shows an example active power command Pdem1. FIG. 10 shows an example active power command Pdem2.

As described above, according to the wind turbine generator system 1, the control apparatus therefor, and the control method therefor of this embodiment, an output-power prediction curve of the wind turbine is generated from the wind-condition prediction information, and the first target electric-power value Pd1 is set for making the reserve electric energy W_pot in each time segment in this output-power prediction curve match the demand reserve electric energy W_ref demanded by the grid side. Then, when output-power reduction control is demanded in terms of electric energy by the grid side, an active power command value is generated based on this first target electric-power value Pd1.

In this way, since the control function for making the reserve electric energy in each time segment match the demand reserve electric energy is provided, even if an output-power reduction demand is made in terms of electric energy from the grid side, it is possible to swiftly respond thereto.

Although the output-power predicting section 31 is provided in the central control system 2 in this embodiment, the output-power predicting section 31 may be provided in each wind turbine control device 20. Furthermore, a configuration in which the functions of the wind turbine control device 20 are provided in the central control system 2, and the central control system 2 sends an active power command to each wind turbine control device 20 may be used.

The first setting section 32 and the second setting section 33 are provided in this embodiment. However, in another aspect of this embodiment, for example, a configuration in which only the first setting section 32 is provided, and an active power command is generated always by using the first target electric-power value Pd1 set by the first setting section 32 may be used.

### REFERENCE SIGNS LIST

1 wind turbine generator system
10-1, 10-n wind turbines
2 central control system
3 utility grid
20 wind turbine control device
31 output-power predicting section
32 first setting section
33 second setting section
34 selection section
35 active-power-command generating section
A interconnection point

1. A wind-turbine-generator-system control apparatus that is applied to a wind turbine generator system in which output powers of a plurality of wind turbines are supplied to a utility grid via a common interconnection point, the control apparatus comprising:
an output-power predicting section that estimates a future output-power prediction curve from wind-condition prediction information indicating predicted future wind conditions; and
a first setting section that divides the output-power prediction curve estimated by the output-power predicting section into a predetermined number of time segments and sets, for each of the time segments, a first target electric-power value for making reserve electric energy in the corresponding time segment match demand reserve electric energy demanded by the grid side,
wherein the first setting section sets the first target electric-power value such that the integral value of electric powers each obtained by subtracting the first target electric-power value from an output-power prediction value at each time in each of the time segments match the demand reserve electric energy, and
wherein the output power of each of the wind turbines is controlled based on the first target electric-power value.

2. (canceled)

3. A wind-turbine-generator-system control apparatus according to claim 1, further comprising:
a second setting section that sets a second target electric-power value obtained by subtracting a predetermined amount from an estimated output power determined based on a rotor rotational speed and a generator output power; and
a selection section that selects the first target electric-power value or the second target electric-power value according to a demand from the grid side,
wherein the output power of each of the wind turbines is controlled based on the target electric-power value selected by the selection section.

4. A wind-turbine-generator-system control method that is applied to a wind turbine generator system in which output powers of a plurality of wind turbines are supplied to a utility grid via a common interconnection point, the control method comprising:
an output-power estimating step of estimating a future output-power prediction curve from wind-condition prediction information indicating predicted future wind conditions; and
a first setting step of dividing the estimated output-power prediction curve into a predetermined number of time segments and setting, for each of the time segments, a first target electric-power value for making reserve electric energy in the corresponding time segment match demand reserve electric energy demanded by the grid side,
wherein the first setting step includes setting the first target electric-power value such that the integral value of electric powers each obtained by subtracting the first target electric-power value from an output-power prediction value at each time in each of the time segments match the demand reserve electric energy, and
wherein the output power of each of the wind turbines is controlled based on the first target electric-power value.

5. A wind turbine generator system comprising:
a plurality of wind turbines; and
a wind-turbine-generator-system control apparatus according to claim 1.

6. A wind turbine generator system according to claim 5,
wherein the wind-turbine-generator-system control apparatus comprises:
wind turbine control devices respectively provided in the wind turbines; and
a central control system that collectively controls the wind turbines,
the central control system comprises the output-power predicting section, and
each of the wind turbine control devices comprises the first setting section.

7. (canceled)

8. A wind-turbine-generator-system control method according to claim 4, further comprising:
a second setting step of setting a second target electric-power value obtained by subtracting a predetermined amount from an estimated output power determined based on a rotor rotational speed and a generator output power; and
a selecting step of selecting the first target electric-power value or the second target electric-power value according to a demand from the grid side,
wherein the output power of each of the wind turbines is controlled based on the target electric-power value selected at the selecting step.
